(19) United States
(12) Patent Application Publication
(10) Pub. No.: US 2010/0249975 A1
(43) Pub. Date: Sep. 30, 2010

(54) SYSTEM AND METHOD FOR SUSTAINABILITY ANALYSIS

(75) Inventor: Mohsen Rezayat, Terrace Park, OH (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Product Lifecycle Management Software Inc., Plano, TX (US)

(21) Appl. No.: 12/630,900

(22) Filed: Dec. 4, 2009

Related U.S. Application Data
(60) Provisional application No. 61/162,911, filed on Mar. 24, 2009.

(51) Int. Cl. G06F 19/00

(52) U.S. Cl. 700/106

(57) ABSTRACT

A method for sustainability analysis, and related data processing system and computer-readable medium. One method includes loading product assembly data, the product assembly data including a plurality of components. The method also includes loading sustainability data for the plurality of components, the sustainability data including, for each component, values for a plurality of criteria for each of a plurality of product lifecycle phases. The method also includes receiving a component selection and a phase selection. The method also includes displaying a sustainability output according to the component selection and phase selection.

### CROSS-REFERENCE TO OTHER APPLICATION

This application claims priority from U.S. Provisional Patent Application 61/162,911, filed Mar. 24, 2009, which is hereby incorporated by reference.

### TECHNICAL FIELD

The present disclosure is directed, in general, to systems for product design and development.

### BACKGROUND OF THE DISCLOSURE

Evaluating the sustainability of a product is increasingly important in light of current environmental concerns and considerations.

### SUMMARY OF THE DISCLOSURE

Various embodiments include a method for sustainability analysis, and related data processing system and computer-readable medium. One method includes loading product assembly data, the product assembly data including a plurality of components. The method also includes loading sustainability data for the plurality of components, the sustainability data including, for each component, values for a plurality of criteria for each of a plurality of product lifecycle phases. The method also includes receiving a component selection and a phase selection. The method also includes displaying a sustainability output according to the component selection and phase selection.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts an example of a Bill of Sustainability (BOS) output graph 205 for a product as extracted and processed (E&P);

FIG. 3 depicts an example of a Bill of Sustainability (BOS) output graph 305 for a product as designed and manufactured (D&M);

FIG. 4 depicts an example of a Bill of Sustainability (BOS) output graph 405 for a product as packaged and sold (P&S);

FIG. 5 depicts an example of a Bill of Sustainability (BOS) output graph 505 for a product as used and maintained (U&M);

FIG. 6 depicts an example of a Bill of Sustainability (BOS) output graph 605 for a product as recovered and recycled (R&R);

FIG. 7 depicts an example of a Bill of Sustainability (BOS) output graph 705 for a product as a whole, in total;

FIG. 8 shows an exemplary view of an automotive assembly; and

FIG. 9 depicts a flowchart of a process in accordance with various embodiments.

### DETAILED DESCRIPTION

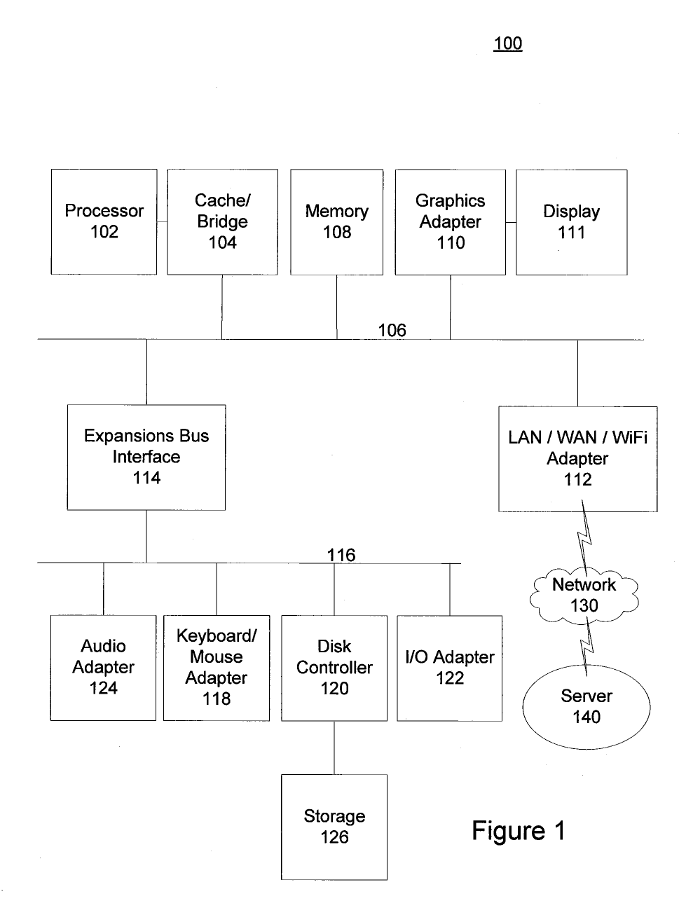

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Sustainability refers to meeting present needs without compromising the future environmental and other needs. The Bill of Sustainability (BOS) system and method described herein represents the simultaneous environmental, social, and economical impacts of any product during its full lifecycle and can visually indicate the overall sustainability of processes and activities associated with any product in any industry. Various embodiments can facilitate comparison of alternate sustainability solutions with company targets and industry best practices.

Various embodiments consider the five product lifecycle phases and the twelve sustainability criteria, and present these in a unique visual representation.

In some embodiments, the disclosed BOM system provides all the parts, materials, alternatives (substitutes), costs, and counts for a complete product in a comprehensive view such as a single indentured or flat list. Various embodiments can also produce a comprehensive of the sustainability (environmental/social/economical) costs, impacts, and benefits of alternative materials or procedures for the full lifecycle of a product.

FIG. 1 depicts a block diagram of a data processing system in which an embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments provide a full “Cradle-to-Cradle” view of a product cycle from a sustainability perspective, and allow a user to modify the design to see the resulting sustainability impact. The Bill of Sustainability (BOS) can be compared to a product's Bill of Materials (BOM). The advantage of BOM is that, on a single indentured or flat list, it includes all the parts, materials, alternatives (replacements), their cost and their count for a complete product. Similarly, the disclosed BOS system can present the sustainability (environmental/social/economical) costs and impacts, and benefits of alternative materials or procedures, for the full lifecycle of a product, both in a flat list format, and in an intuitive graphic format.

According to various embodiments, the BOS analyzes the sustainability impact of various stages of a product lifecycle. Phase I considers the product as extracted and processed (E&P). Phase II considers the product as designed and manufactured (D&M). Phase II considers the product as packaged and sold (P&S), Phase IV considers the product as used and maintained (U&M), and Phase V considers the product as recovered and recycled (R&R). Other considerations can include new product design including standards and regulations, product manufacturing, product packing, shipping, and sales, product use including maintenance, product end-of-life recovery, reporting, and management, and product disassembly, disposal, and reporting.

Sustainability can be considered in terms of social, environmental, and economic sustainability. According to various embodiments, each phase of the BOS considers twelve sustainability criteria: energy efficiency, water efficiency, emission efficiency, waste efficiency, recycle efficiency, other environmental factors, quality of work, safety in general, other social factors, use of renewables, cost efficiency, and other economic factors.

In various embodiments, each of the five phases, and a compiled total, can be displayed by the system on a radar graph that shows an easy and intuitive view of the sustainability criteria. Scoring is done based on sustainability indices, which can be either the area of the region for each solution or a percentage of “standards” area.

Scoring can be done in terms of either sustainability impact or efficiency. In the examples depicted, “efficiency” is shown as the scoring method, with greater efficiency having a greater score for each criteria, resulting in a larger total area. In these examples, each criteria is scored for efficiency on a scale of 0-5.

If scored by “impact,” then the smaller the area the better; if scored for “efficiency,” the larger the area in the radar chart the better. Index scoring can be compared for each phase of the BOS. An overall sustainability index can be obtained by adding or other wise combining all five indices.

The system can also use weighting factors to show that certain criteria in a specific phase are more important than others due to timescale, industry, or impact. An optimal solution is determined by the system by comparing the weighted overall sustainability indices of various solutions and industry best practices, storing them, and displaying them as described.

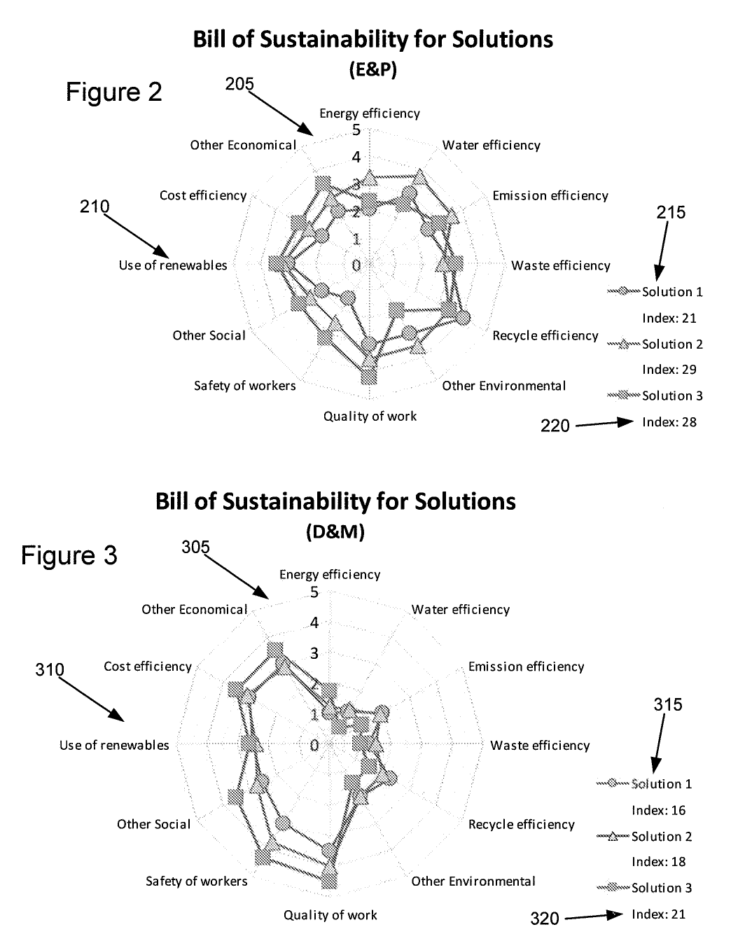

FIG. 2 depicts an example of a Bill of Sustainability (BOS) output graph 205 for a product as extracted and processed (E&P). Such an output graph can be produced for each particular component, such as would be listed in a Bill of Materials, in an assembly, or can be produced for a product assembly as a whole. Each of the twelve criteria 210 are evaluated at this phase, showing the score for the product for each criteria. Note that multiple possible product solutions can be simultaneously displayed, as indicated by legend 215, and the total index score 220 for each solution is also displayed. A user can easily see the optimal solution by finding the solution with the highest index, which is also reflected as the greatest total area in output graph 205.

FIG. 3 depicts an example of a Bill of Sustainability (BOS) output graph 305 for a product as designed and manufactured (D&M). Such an output graph can be produced for each particular component, such as would be listed in a Bill of Materials, in an assembly, or can be produced for a product assembly as a whole. Each of the twelve criteria 310 are evaluated at this phase, showing the score for the product for each criteria. Note that multiple possible product solutions can be simultaneously displayed, as indicated by legend 315, and the total index score 320 for each solution is also displayed. A user can easily see the optimal solution by finding the solution with the highest index, which is also reflected as the greatest total area in output graph 305.

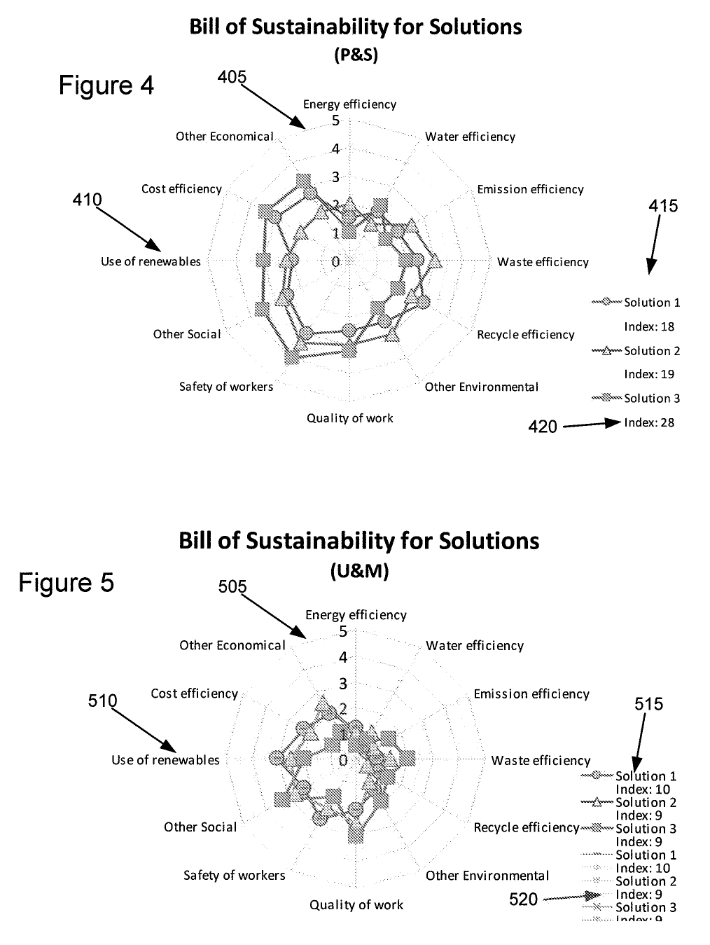

FIG. 4 depicts an example of a Bill of Sustainability (BOS) output graph 405 for a product as packaged and sold (P&S). Such an output graph can be produced for each particular component, such as would be listed in a Bill of Materials, in an assembly, or can be produced for a product assembly as a whole. Each of the twelve criteria 410 are evaluated at this phase, showing the score for the product for each criteria. Note that multiple possible product solutions can be simultaneously displayed, as indicated by legend 415, and the total index score 420 for each solution is also displayed. A user can easily see the optimal solution by finding the solution with the highest index, which is also reflected as the greatest total area in output graph 405. For this phase of BOS, in this example, “Solution 3” seems to offer the optimal solution with an Index of 28, but this is only one part of the complete lifecycle. In this example, all shown results are based on equal weighting. “Solution 3” can be compared, for example, with alternate assemblies, or compared with industry best and average solutions. In other examples, criteria results can be weighted with higher weight for energy efficiency, for example, but lower weight for quality because this is the packaging phase.

FIG. 5 depicts an example of a Bill of Sustainability (BOS) output graph 505 for a product as used and maintained (U&M). Such an output graph can be produced for each particular component, such as would be listed in a Bill of Materials, in an assembly, or can be produced for a product assembly as a whole. Each of the twelve criteria 510 are evaluated at this phase, showing the score for the product for each criteria. Note that multiple possible product solutions can be simultaneously displayed, as indicated by legend 515, and the total index score 520 for each solution is also displayed. A user can easily see the optimal solution by finding the solution with the highest index, which is also reflected as the greatest total area in output graph 505.

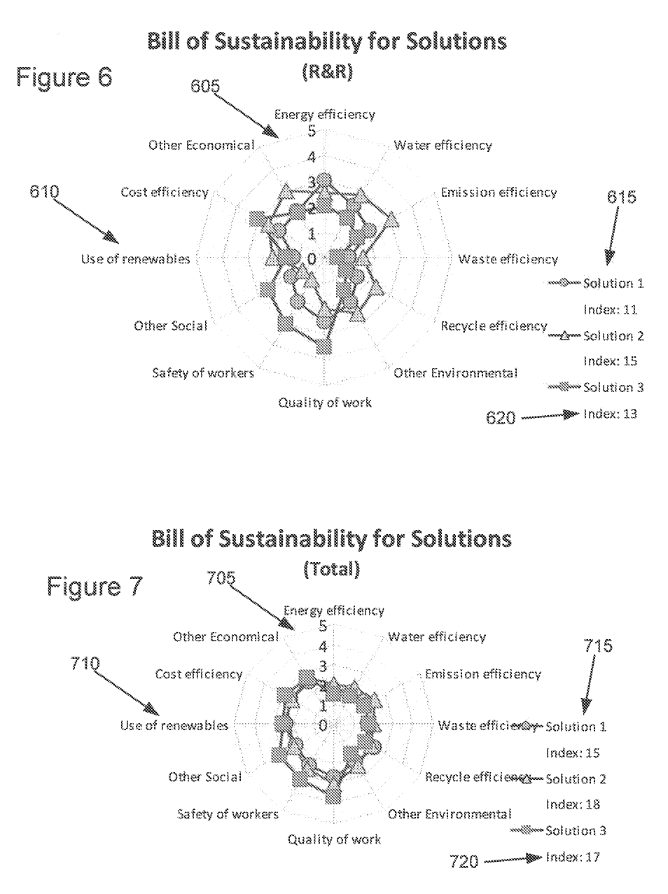

FIG. 6 depicts an example of a Bill of Sustainability (BOS) output graph 605 for a product as recovered and recycled (R&R). Such an output graph can be produced for each particular component, such as would be listed in a Bill of Materials, in an assembly, or can be produced for a product assembly as a whole. Each of the twelve criteria 610 are evaluated at this phase, showing the score for the product for each criteria. Note that multiple possible product solutions can be simultaneously displayed, as indicated by legend 615, and the total index score 620 for each solution is also displayed. A user can easily see the optimal solution by finding the solution with the highest index, which is also reflected as the greatest total area in output graph 605.

FIG. 7 depicts an example of a Bill of Sustainability (BOS) output graph 705 for a product as a whole, in total. The total figures are produced by combining the individual scores at each of the other phases, by summing, averaging, or otherwise, and can be weighted to emphasize particular phases. Such an output graph can be produced for each particular component, such as would be listed in a Bill of Materials, in an assembly, or can be produced for a product assembly as a whole. Each of the twelve criteria 710 are evaluated at this phase, showing the score for the product for each criteria. Note that multiple possible product solutions can be simultaneously displayed, as indicated by legend 715, and the total index score 720 for each solution is also displayed. A user can easily see the optimal solution by finding the solution with the highest index, which is also reflected as the greatest total area in output graph 705.

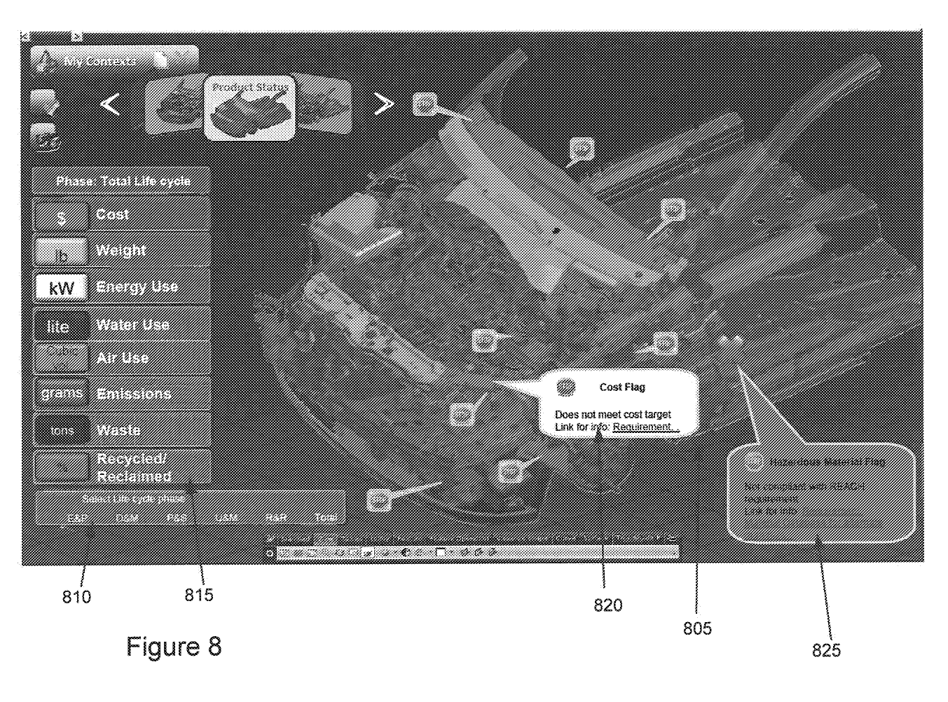

The system can also display a product assembly view, where each component can be highlighted in color or otherwise to display particular sustainability issues at each phase or for the total lifecycle. FIG. 8 shows an exemplary view of an automotive assembly 805. This output view can display the sustainability status at the full assembly, subassembly, part, and component levels (including supplier status) for the overall life cycle and the individual phases, using selection area 810. The system can also normalize these each criteria and phase value to enable comparisons between option A and option B or product A and product B. This output view can include a selection area 815 for selecting specific sustainability factors, and corresponding components of the assembly will be highlighted to show sustainability issues related to that factor in assembly 805. This display can also indicate components that do not meet particular sustainability requirements, as at 820, and indicate other issues to be considered, such as with the hazardous material flag 825.

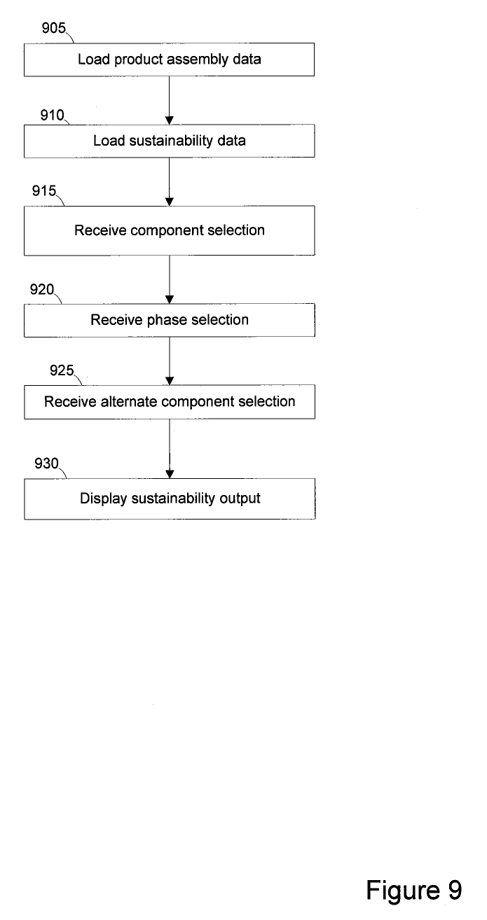

FIG. 9 depicts a flowchart of a process in accordance with various embodiments.

The system loads product assembly data (step 905). The product assembly data can be a CAD product assembly that identifies each component in the assembly and other information such as their interactions, connections, and other manufacturing details. This product assembly data can be a bill of materials for a product, identifying some or all specific components.

“Loading” as used herein can include loading from storage, receiving from another system, for example over a network, receiving through an interaction with a user, or otherwise.

The system loads sustainability data for some or all components in the product assembly data (step 910). The sustainability data includes values for each of the sustainability criteria at each of the five phases described above. The sustainability data can also include industry best and industry average values for each of these criteria, and can include similar data for alternate components corresponding to one or more of the components in the product assembly data. Of course, the sustainability data can be combined with the product assembly data, and in such a case, steps 905 and 910 could be combined.

The system receives, from a user, a component selection of one or more components of the assembly (or of the entire assembly) (step 915).

The system receives, from a user, a phase selection of the product lifecycle phase to be processed, including one of the five phases identified above or the entire product lifecycle (step 920).

The system optionally receives, from a user, a selection of alternate components that define an alternate assembly (step 925). These alternate components can be actual alternate components that substitute for one or more original components in the assembly and have different values for the various sustainability criteria, or they can be proxy components that include industry best and industry average values for each of these criteria.

The system optionally normalizes values according to the sustainability data (step 930). In some embodiments, the first step in normalizing values is to define fields that need to be normalized, which the system performs by adding entries to a properties file. Each entry defines a target field, the phase and criteria that for which the target is valid, and the part attributes that should be compared against the target field.

Once the fields have been defined, the system can receive target values for each part, for example from a user. Targets can be maintained in a table that reflects the available targets for each phase and criteria.

If targets have been entered, normalized values are calculated by the system after the process values are calculated as described below. These values can be combined to calculate a single number for each phase's criteria, and each phase, for each assembly in the BOM. Weights for each target can be specified in the target definition. When the values are combined, these weights are taken into account. Both the normalized and combined values are stored is the system as associated with the part. These values are shown in the sustainability output described below, in a summary custom table view (CTV) table, any radar diagrams, and in any other appropriate sustainability output or report.

The system stores and displays a sustainability output according to the component selection, phase selection, and any alternate assembly (step 935). This sustainability output, in various embodiments, is a radar graph as depicted in the figures above, indicating the sustainability values for the selected components or assembly, for each of the twelve criteria in the selected phase or total lifecycle. The sustainability output can be an assembly view, as described above with regard to FIG. 8, indicating sustainability status at the full assembly, subassembly, part, and component levels (including supplier status) for the overall life cycle and the individual phases, for example.

In other embodiments, the system can display the sustainability output as multiple solutions in the alternative. Solutions are represented by revisions of the BOM. Each revision that matches a predefined pattern is considered a solution and can have its own sustainability data. The user can choose to show sustainability information for different solutions on the summary radar diagram by selecting the solution and clicking an input such as a “Toggle in Radar” button. This will add the solution to the radar diagram, allowing the sustainability information to be compared between solutions.

In some cases, the sustainability data of step 910 can include sustainability process values that are standardized in the industry. Sustainability information for processes (such as the environmental impact of extracting 1 kilogram of aluminum, or of transporting 1 kilogram of material via truck 500 miles) can be obtained, for example, from the US Life-Cycle Inventory (LCI) database that can be accessed at time of filing at www.nrel.gov/lci/assessments.html. This database is included data in a standard format that can be used in various embodiments described herein, either directly or by converting to an appropriate format.

In some embodiments, as part of loading the assembly and sustainability data, a user can specify the processes relevant to each part on Custom Table View tables in a Manufacture Process Planning interface of the system. As sustainability data is updated by the system, these processes are used to look up the appropriate sustainability values from the database. These values can then be stored in the system as associated with the part. Once the process values are stored with the part, the system can calculate a product of the weight of the part and the process values to get the sustainability values for the part.

For example, a part may require 0.5 kg of aluminum for a bracket. From the LCI database, the system can determine that during the processing of 1 kg of aluminum, 0.00005 cubic meters of CO2 are produced. Multiplying that number by the weight of the part gives results in 0.000025 cubic meters of CO2 produced to process the aluminum needed for the part.

Another way to import material data is by using importing data from an IPC 1752 PDF form. This form can be filled out by a supplier, and exported to XML. The XML can then be imported into the system. This import process creates a material structure associated with the selected part. Once the material data is imported, the resulting material structure can be used to look up LCI data by using the name or CAS number of the material or its substances.

IPC 1752 is a well known standard for the exchange of materials declaration data, developed in cooperation with the National Institute of Standards and Technology.

In some embodiments, a product such as the Supplier Relationship Manager (SRM) application by Siemens Product Lifecycle Management Software, Inc. can be used to gather part information, such as material data, from suppliers, using a format similar to the IPC 1752 form. For example, a product developer can create an SRM event for a part. Suppliers can then log in to SRM and enter their information. When the product developer awards the event to a supplier, the material and compliance data is transmitted from SRM to a system such as that disclosed herein, and stored as associated with the part.

In some embodiments, the sustainability data can also be exported from the system. For example, the user can export the normalized values shown on the sustainability output to a spreadsheet, which can allow the user to compare the chosen solution against industry or company targets, or to compare solutions at different time periods.

Some embodiments also support user-instruction manuals. For example, a user can create documents associated with a part in the system. These documents could be about hazardous-substance handling, user manuals, end-of-life instructions, etc. Such documents are stored as an attachment as associated with a part.

Significant advantages of the disclosed system over known systems include the scope and presentation functions described herein. Using the disclosed systems, customers can at any time integrate all sustainability dimensions and represent them by a single “index” or dissect and analyze/optimize them individually. Also, the systems disclosed herein can visually indicate the overall efficiency of processes and activities associated with any product in any industry, and facilitate comparison of alternate sustainability solutions or track achievement of targets. Finally, by dissecting the BOS into phases and components, the disclosed embodiments promote the concept of top-down and bottom-up design and analysis and make it possible for customers and other users to deal with a very complex problem in a simple and straightforward manner.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for sustainability analysis, comprising:
loading product assembly data in a data processing system, the product assembly data including a plurality of components;
loading sustainability data for the plurality of components in the data processing system, the sustainability data including, for each component, values for a plurality of criteria for each of a plurality of product lifecycle phases;
receiving, from a user and by the data processing system, a component selection;
receiving, from a user and by the data processing system, a phase selection; and
displaying, by the data processing system, a sustainability output according to the component selection and phase selection.

2. The method of claim 1, wherein the phase criteria include energy efficiency, water efficiency, emission efficiency, waste efficiency, recycle efficiency, other environmental factors, quality of work, safety in general, other social factors, use of renewables, cost efficiency, and other economic factors related to the respective component.

3. The method of claim 1, wherein the product lifecycle phases include a product as extracted and processed, as designed and manufactured, as packaged and sold, as used and maintained, and as recovered and recycled.

4. The method of claim 1, wherein the component selection includes a selection of one or more of the plurality of components or of an entire product assembly.

5. The method of claim 1, wherein the phase selection includes a selection of a one of five product lifecycle phases or of an entire product lifecycle.

6. The method of claim 1, further comprising receiving a selection of alternate components that define an alternate assembly.

7. The method of claim 1, wherein the sustainability output is a radar graph indicating the values for each of the plurality of criteria for the component selection and phase selection.

8. A data processing system comprising a processor and accessible memory, the data processing particularly configured to perform the steps of:
loading product assembly data, the product assembly data including a plurality of components;
loading sustainability data for the plurality of components, the sustainability data including, for each component, values for a plurality of criteria for each of a plurality of product lifecycle phases;
receiving a component selection from a user;
receiving a phase selection from a user; and
displaying a sustainability output according to the component selection and phase selection.

9. The data processing system of claim 8, wherein the phase criteria include energy efficiency, water efficiency, emission efficiency, waste efficiency, recycle efficiency, other environmental factors, quality of work, safety in general, other social factors, use of renewables, cost efficiency, and other economic factors related to the respective component.

10. The data processing system of claim 8, wherein the product lifecycle phases include a product as extracted and processed, as designed and manufactured, as packaged and sold, as used and maintained, and as recovered and recycled.

11. The data processing system of claim 8, wherein the component selection includes a selection of one or more of the plurality of components or of an entire product assembly.

12. The data processing system of claim 8, wherein the phase selection includes a selection of a one of five product lifecycle phases or of an entire product lifecycle.

13. The data processing system of claim 8, the data processing system further configured to receive a selection of alternate components that define an alternate assembly.

14. The data processing system of claim 8, wherein the sustainability output is a radar graph indicating the values for each of the plurality of criteria for the component selection and phase selection.

15. A tangible computer readable medium encoded with computer-executable instructions that, when executed, cause a data processing system to perform the steps of:
loading product assembly data, the product assembly data including a plurality of components;
loading sustainability data for the plurality of components, the sustainability data including, for each component, values for a plurality of criteria for each of a plurality of product lifecycle phases;
receiving a component selection from a user;
receiving a phase selection from a user; and
displaying a sustainability output according to the component selection and phase selection.

16. The computer readable medium of claim 15, wherein the phase criteria include energy efficiency, water efficiency, emission efficiency, waste efficiency, recycle efficiency, other environmental factors, quality of work, safety in general, other social factors, use of renewables, cost efficiency, and other economic factors related to the respective component.

17. The computer readable medium of claim 15, wherein the product lifecycle phases include a product as extracted and processed, as designed and manufactured, as packaged and sold, as used and maintained, and as recovered and recycled.

18. The computer readable medium of claim 15, wherein the component selection includes a selection of one or more of the plurality of components or of an entire product assembly.

19. The computer readable medium of claim 15, wherein the phase selection includes a selection of a one of five product lifecycle phases or of an entire product lifecycle.

20. The computer readable medium of claim 15, further including instructions causing the data processing system to receive a selection of alternate components that define an alternate assembly.

21. The computer readable medium of claim 15, wherein the sustainability output is a radar graph indicating the values for each of the plurality of criteria for the component selection and phase selection.
